(19) United States
(12) Patent Application Publication
(10) Pub. No.: US 2026/0292673 A1
(43) Pub. Date: Sep. 24, 2026

(54) WIRELESS ACCESS POINT SCORING

(71) Applicant: Intel Corporation, Santa Clara, CA (US)

(72) Inventors: Dong-Ho HAN, Beaverton, OR (US); Michael SHUSTERMAN, Portland, OR (US); Ido OUZIELI, Tel Aviv (IL); Kobi GUETTA, Netanya (IL); Ofer KIMELMAN, Tel-Aviv (IL); Farnaz FOROUGHIAN, Hillsboro, OR (US); Joy PODDAR, Bangalore (IN)

(21) Appl. No.: 19/084,899

(22) Filed: Mar. 20, 2025

(51) Int. Cl. H04W 48/20; H04W 84/12

(52) U.S. Cl. CPC H04W 48/20; H04W 84/12

(57) ABSTRACT

A device may include a receiver, configured to receive a first signal from a first internet access point (AP) transmitting on a first channel, and receive a second signal from a second internet AP transmitting on a second channel; and a processor, configured to determine a platform noise of the device; determine a first interference of the platform noise of the device in the first channel and a second interference of the platform noise of the device in the second channel; generate a first ranking of the first AP based on the first signal and the first interference; generate a second ranking of the second AP based on the second signal and the second interference; and select either the first AP or the second AP for connection based on the first ranking and the second ranking.

### BACKGROUND

Personal computers (PCs) commonly connect to the Internet via the family of Institute of Electrical and Electronics Engineers (IEEE) 802.11 protocols, which may be commonly referred to as Wi-Fi. Wi-Fi performance, and therefore also the corresponding user experience (UX) resulting from the use of Wi-Fi, are highly sensitive to the Wi-Fi receiver's signal-to-noise ratio (SNR). That is, poor SNR can result in poor connection, disconnection, latency, and error; and each of these may diminish the user's experience. In client PCs, Wi-Fi receivers and antennas may be exposed to radio frequency (RF) energy from nearby electronic components and interconnects. These radiations may be understood as noise from the perspective of the device's Wi-Fi receiver, and they can degrade the SNR at the receiver. This degraded SNR may significantly reduce Wi-Fi throughput or inhibit Wi-Fi connections and associations.

Client PCs typically select an access point (AP) for Wi-Fi connection to the internet based on a plurality of network parameters, which may conventionally include any of signal strength, loading, and channel bandwidth. However, overlooking the client Wi-Fi channel's RF interference status and relying solely on signal strength can lead to suboptimal AP selection, thereby negatively affecting the user experience. Client Wi-Fi devices may commonly suffer from 10-20 dB de-sense (e.g., noise from other device components; platform noise). Given this noise, conventional AP selection procedures, which may not take into account this additional de-sense noise, could result in misleading or suboptimal AP selection, such as due to the 10-20 dB SNR estimation gaps.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary embodiments of the disclosure are described with reference to the following drawings, in which:

FIG. 1 depicts a simplified diagram of a conventional Wi-Fi AP scoring procedure;

FIG. 2 depicts a representative client device with two Wi-Fi antennas that are integrated in close proximity to sources of significant platform noise;

FIG. 3 depicts the generation of a platform noise table for use in AP scoring;

FIGS. 4A and 4B depict an example of the proposed platform noise or de-sense characterization method as applied to a real device;

FIG. 5 depicts the addition of an AP scoring penalty to the AP scoring method depicted in FIG. 1;

FIG. 6 depicts the scoring procedure according to case 1;

FIG. 7 depicts the scoring procedure according to case 2;

FIG. 8 depicts the scoring procedure according to case 3; and

FIG. 9 depicts a device.

### DESCRIPTION

The following detailed description refers to the accompanying drawings that show, by way of illustration, exemplary details and embodiments in which aspects of the present disclosure may be practiced.

The word “exemplary” is used herein to mean “serving as an example, instance, or illustration”. Any embodiment or design described herein as “exemplary” is not necessarily to be construed as preferred or advantageous over other embodiments or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. Unless otherwise specified, references to “memory” included herein may thus be understood as referring to volatile or non-volatile memory, including random access memory (RAM), read-only memory (ROM), flash memory, solid-state storage, magnetic tape, hard disk drive, optical drive, 3D XPoint™, among others, or any combination thereof. Registers, shift registers, processor registers, data buffers, among others, are also embraced herein by the term memory. The term “software” refers to any type of executable instruction, including firmware.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

The AP scoring method disclosed herein considers not only the received signal strength indicator (RSSI) but also the client device's channel de-sense factors. Although this AP scoring method may require additional pre-characterization (e.g., mapping from a de-sense factor to a channel number) for client devices, it results in improved AP selection compared to conventional methods. Additionally, the AP scoring method allows for flexible performance trade-offs or balancing between the client device's CPU/memory and Wi-Fi during the AP selection process, such as by using AP score penalties.

For context, one prior attempt to reduce the negative effect of de-sense on AP selection has been to incorporate shielding within the client device, such that the shielding blocks or absorbs noise from the device's components (e.g., from the memory), thereby protecting the receiver from this noise. Such shielding, however, increases the overall expense of manufacturing the client device and may therefore be undesirable. Another attempt to reduce the negative effects of de-sense has been to institute antenna keep-out zones in which antennas are placed father away from the noise sources, which may result in attenuation of the noise before reaching the receiver's antenna. Thus may not, however, always be possible, and it may increase the complexity of the component layout. A third attempt to reduce the negative effects of de-sense has been to rely on complex package and printed circuit board (PCB) layout and routing rules, such as by burying or covering noisy data lanes, and by limiting routing nets and lengths on the package or PCB surface. This, however, significantly increases the complexity of the mechanical and PCB design rules, which correspondingly increases the cost, such as by increasing the system z-height, the PCB area, and/or the layer count. Other efforts have included static frequency planning, wherein the operating frequencies of noise-generating components are permanently set to frequencies whose fundamental frequencies and harmonics fall outside of the Wi-Fi bands. This is, however, seldom feasible in a real-world system and may frequently lead to data rates that are not competitive and/or diminished user experience.

To overcome this last challenge, procedures have been developed to implement a handshake protocol between a victim wireless component and an aggressor (e.g., between a receiver and a double data rate (DDR) memory) and to dynamically shift the aggressor's operating frequency away from the wireless operating channel used by the victim. A significant drawback of this method, however, is that it may compromise the aggressor's ability to function at its optimal operational point. For instance, in scenarios involving DDR memory, the DDR memory might be forced to shift to a suboptimal operating point. This adjustment can lead to a decline in overall performance, thereby adversely affecting platform latency and power consumption.

In light of the foregoing, it is desired to improve the Wi-Fi AP selection algorithm by considering SNR and thereby decreasing the aforementioned CPU and/or memory performance penalties. In the following, the client device assigns scores to neighboring wireless APs. These scores may be assessed based on RSSI criteria, and the client device may rank the APs by prioritizing APs that operate on channels unaffected by RF noise (or with lower RF noise), assuming all other conditions are equal. This strategy may also differentiate among types of RF interferences and may assign different score penalties according to their severity on CPU and/or memory performance. When all detected APs are operating on RF interference contaminated channels, this AP scoring method may prioritize an AP leading to the least impairment on CPU and/or memory performance. In this manner, improved AP selection can be achieved in environments with multiple APs. In this manner, components responsible for emitting noise may remain unaffected and can continue their operations without disruption from the noise's victim. Moreover, by considering SNR rather than merely RSSI, the AP rating procedure disclosed herein improves AP selection, thereby leading to improved reliability and increased throughput.

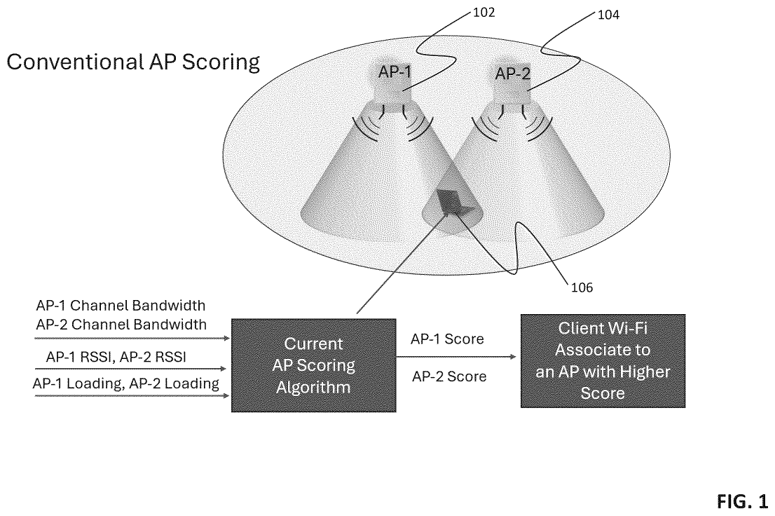

FIG. 1 depicts a simplified diagram of a conventional Wi-Fi AP scoring procedure. In this conventional procedure, a client Wi-Fi device scores a plurality of APs, depicted for simplicity herein as AP-1 102 and AP-2 104, to determine a preferential AP for connection. The Wi-Fi device 106 performs the scoring based on any of multiple key network parameters, including theoretical throughputs calculated from channel bandwidths (e.g., 20 MHz, 40 MHz, 80 MGz, 160 MHz, etc.), RSSI, the number of serving client devices, and the AP loading. The client Wi-Fi device then selects the AP with the highest score for connection (e.g., association).

Of note, the conventional scoring procedure does not consider platform noise. That is, it can be seen from FIG. 1 that the conventional scoring algorithm may consider any of channel bandwidth, received signal strength indicator (RSSI), and AP loading. In the scoring procedure described herein, however, the client Wi-Fi device considers its own non-ideal platform noise conditions. Critically, however, the RSSI, which generally represents a power of signals received by the client device, does not distinguish between the power of the intended received signal (e.g., a signal transmitted to the client device by the AP) and platform noise. Thus, a particularly high RSSI may indicate a very strong signal from the AP, a great amount of platform noise, or any combination thereof. As such, RSSI must be distinguished from the signal to noise ratio, and RSSI alone is not an ideal measurement with which to determine the strength of the AP's signal once received at the client device.

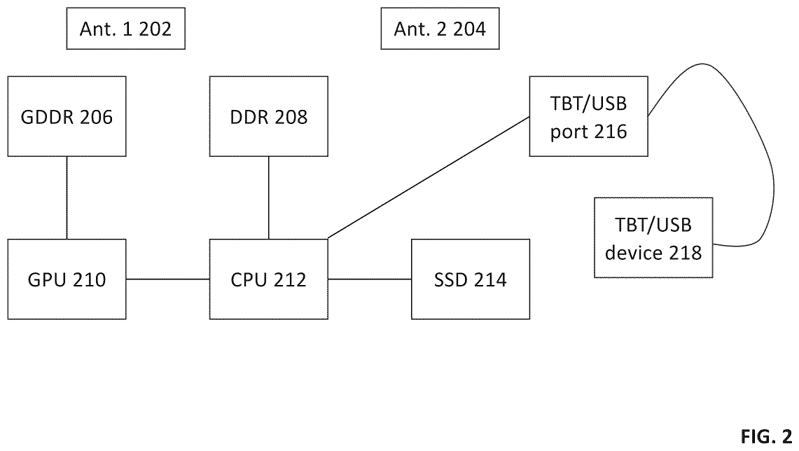

FIG. 2 depicts a representative client device (e.g., a laptop, a tablet, etc.) having two Wi-Fi antennas (202 and 204, respectively) that are integrated in close proximity to sources of significant platform noise. These platform noise sources may include, but are not limited to, dynamic random access memory (DRAM) devices such as any of graphics double data rate (GDDR) memory 206, double data rate (DDR) memory 208, low power double data rate (LPDDR) memory (not depicted), and their corresponding interface interconnects. The platform noise may also come from the graphics processing unit (GPU) 210, the central processing unit (CPU) 212, solid state device (SSD) 214 modules, wherein M.2 connectors (also known as next generation form factor connectors), SSD 214 devices, and their application specific integrated circuit (ASIC) controllers are the primary noise sources. On the other hand, poorly shielded internal cables and connectors are key contributors for thunderbolt and universal serial bus (USB) platform noises, such as signals from a USB port 216 or a USB device 218. Although this is not a comprehensive list of platform noise sources, these represent a significant portion of the relevant noise contributors. This list is not intended to be exhaustive, but is rather provided for illustrative purposes.

FIG. 2 depicts a client device and various noise sources. In modern computing devices (e.g., in laptops, notebook PCs, etc.), the CPU and DDR memory use dynamic voltage and frequency scaling (DVFS) to reduce energy consumption. The skilled person will appreciate that DVFS is a memory power management technique that dynamically adjusts the operating voltage and clock frequency of memory subsystems based on current workload demands. By lowering both the voltage and frequency during periods of low activity, DVFS reduces power consumption and minimizes heat generation. Conversely, DVFS can be used to scale up the voltage and frequency when higher performance is required. This adaptive method helps achieve a balance between energy efficiency and system performance. Of relevant note for the principles described herein, DVFS may often be characterized by four discrete DVFS points, which may be set or determined by the memory manufacturer. For example, one point may be a high performance point that describes the maximum voltage and frequency setting where the memory delivers its highest possible performance. A second point may be a point of energy efficiency, wherein the voltage and frequency are reduced from the first point, which enables the memory to consume less power while still performing many tasks. A third point may correspond to a low-power setting in which the voltage and frequency are further reduced to minimize power substantially, which may permit the memory to continue to perform light workloads and which corresponds to an acceptable performance reduction in favor of energy savings. A fourth point may be the minimum safe operating point, which may represent the lowest voltage and frequency combination that still ensures reliable memory operation without causing errors or instability.

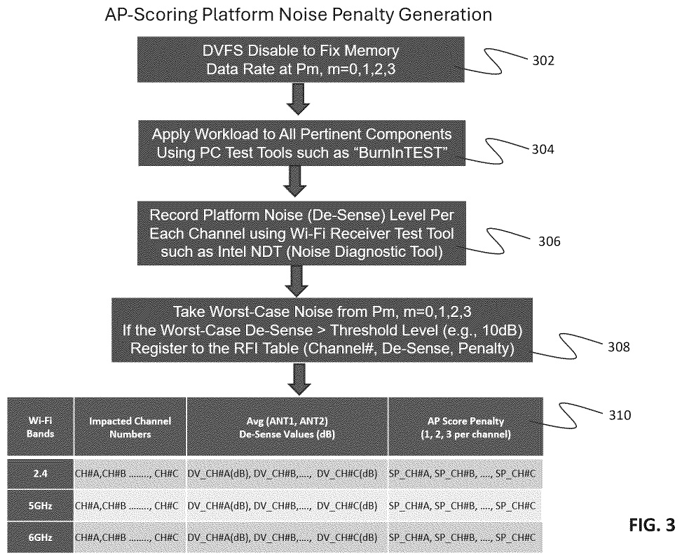

FIG. 3 depicts the generation of a platform noise table for use in the AP scoring method disclosed herein. To characterize the worst-case platform noises, the DVFS feature may be disabled, and the device (e.g., the memory) data rate may be fixed as one of the four separate static behaviors from the four discrete DVFS points described above, which are represented in this figure as Pm, wherein m=0, 1, 2, or 3 302. PC component manufacturers may determine the platform noise generated by their devices at these four levels using any of a variety of measuring techniques or software tools, such as, for example, noise diagnostic tools, and the like. In this manner, the manufacturer may apply a workload to the relevant component and use one or more testing tools (e.g., BurninTEST) to determine a de-sense (e.g., noise) level for the component at that workload at that DVFS setting 304. Using such techniques or software, computer component manufacturers may generate an RF interference mapping table based on their in-situ platform measurements by recording the platform noise (e.g., de-sense) level per each channel using a Wi-Fi receiver test tool 306. The manufacturer may then assume that worst-case scenario from Pm, at m=0, 1, 2, or 3, (e.g., a worst noise level at a first frequency among P=0, 1, 2, and 3; a worse noise level at a second frequency among P=0, 1, 2, and 3, etc.), and if the worst-case de-sense is greater than a threshold level (e.g., 10 dB in one optional configuration), register the channel, de-sense, and a penalty to the RF interference table 308. 310 depicts a possible configuration of the de-sense table in which each row corresponds to a wi-fi band, and in which the columns correspond to impacted channel numbers, average de-sense values, and a corresponding AP score penalty. As stated above, memory devices may be configured to operate according to four discrete DVFS points within the 2.4 GHz band. As can be seen in FIG. 3, 15-20 dB de-sense (e.g., noise relative to the Wi-Fi receiver) could be present across the entire 2.4 GHz band, and Wi-Fi association to any of the corresponding channels would result in a poor Wi-Fi user experience due to the reduced throughput as a result of this de-sense noise. Of note, it may be the case that only DDR memory noises are outstanding in the 6 GHz band, and these noises may be the only major differences from the 4 DVFS points.

The principles disclosed herein may be used as part of a dynamic RF interference avoidance technique, such as to protect CPU and/or memory performance. In some high-end platforms, top DDR memory speeds may be much higher than 6 GHz or may even surpass the 6 GHz band. In such platforms, 6 GHz band noises could be scored with no penalty or a low penalty if a dynamic interference avoidance technique is enabled. For other platforms, top DDR memory speeds could be in 6 GHz band, and those 6 GHz band noises could be scored with a high penalty to prioritize CPU and/or memory performances.

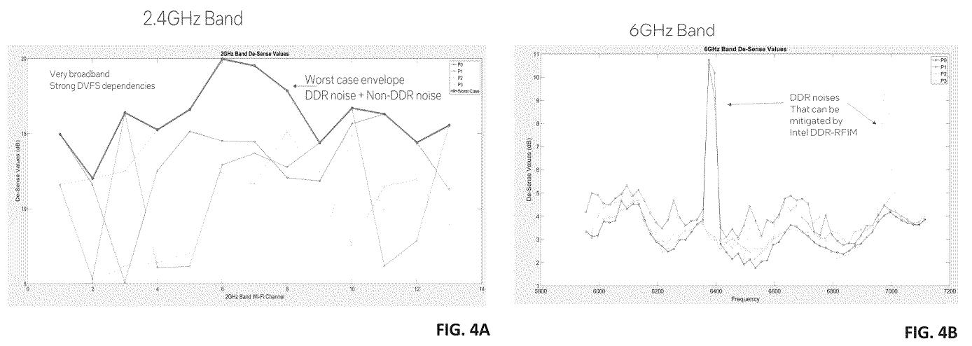

FIGS. 4A and 4B depict an example of the proposed platform noise or de-sense characterization method applied to a real device. In FIG. 4A, a 2.4 GHz band is analyzed and shows strong DVFS dependencies. Four lines of this figure depict noise resulting from a particular DVFS setting, and the bold line at the top of the figure depicts the worst case for each of the four DVFS settings. FIG. 4B depicts a similar analysis within the 6 GHz band. In this figure, however, only two large noise peaks are identified, and as shown, these noise peaks may be able to be remediated by one or more software or hardware implementations, such as a RF inference mitigation module. As can be seen, various platform noises including DDR broadband noises contribute 2.4 GHz band while only DDR narrowband noises are outstanding in 6 GHz band.

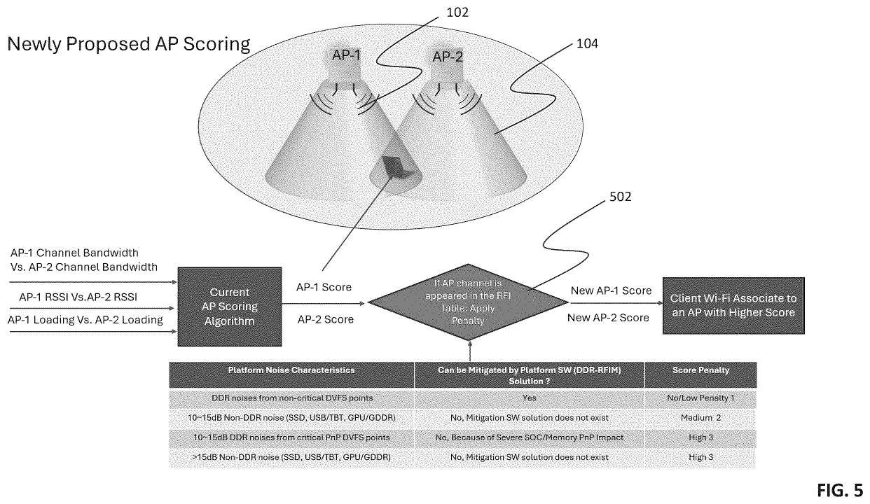

FIG. 5 depicts the additional of an AP scoring penalty to the AP scoring method depicted in FIG. 1. In this figure, the client device scores AP-1 and AP-2, 102 and 104 respectively, to identify a best AP for connection. In addition to the conventional scoring procedure disclosed in FIG. 1, the additional of the scoring penalty 502 is depicted. In this manner, each AP may receive a score according to the conventional scoring method, and then each AP may additionally receive a penalty based on the client device's noise relative to a channel on which the AP is operating. That is, in the conventional process of AP scoring, the client device determines a channel on which the AP is transmitting and, in addition to receiving a score according to the conventional method, the AP will determine whether the channel is on the table described above, and, if so, assess a corresponding penalty point (or multiple penalty points) to the AP.

That is, once a client device produces a mapping table that shows the relationship between de-sense values and the corresponding channel numbers, the score penalty can be defined. Channels that are impacted by DDR memory noise may be assigned a penalty score of 1 because they can be mitigated by a RF interference software mitigation solution and they are caused by non-critical DVFS points. Other channels with 10-15 dB de-sense values caused by SSD, USB, or GPU are scored with a penalty of 2. The de-sense values caused by critical DVFS points scored with a penalty of 3. In these examples, it is expressly noted that a critical DVFS point is a point that is optimized for DDR performance and/or latency. Changing this point may cause platform performance degradation and should generally be avoided.

These scoring definitions aim to minimize CPU and memory power and performance (PnP) impacts by selecting an AP that does not require software RF interference mitigation or DVFS point changes. In other words, the definition prioritizes CPU and memory performance over Wi-Fi performance. Finally, severe de-sense values that are greater than 15 dB, which being so great, can jeopardize Wi-Fi AP connections, are scored with a penalty of 3. It should be mentioned that the Wi-Fi AP scoring algorithm as disclosed herein may scale the score penalty values (e.g., 1, 2, and 3) to make actual AP score points that are comparable to other Wi-Fi network parameters.

According to an aspect of the disclosure, the scoring procedure may be understood as reflecting any one of three possible cases, described herein as case 1, case 2, and case 3.

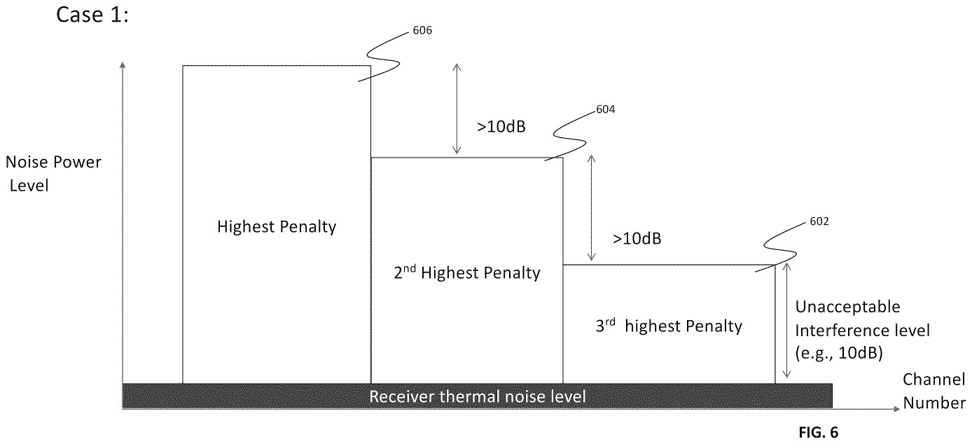

FIG. 6 depicts the scoring procedure according to case 1. In this figure, the wireless performance and the user experience are the primary concern, such as due to the severity of the interference. In this manner, only unacceptable interference may be considered for the scoring algorithm. The unacceptable interference may be interference that is greater than a predetermined threshold, for example. This predetermined threshold may be any threshold, as desired for the implementation. Alternatively, the unacceptable interference may be interference that is greater than a predetermined value greater than the Wi-Fi receiver's thermal noise level. In this manner, the penalty scores may be determined as being 1 (e.g., the third highest penalty) 602 for noise that is less than 10 dB above the Wi-Fi receiver's thermal noise level; 2 (e.g., the second highest penalty) 604 for noise that is greater than 10 dB but less than 20 dB above the Wi-Fi receiver's thermal noise level, and 3 (e.g., the highest penalty) 606 for noise that is greater than 20 dB above the Wi-Fi receiver's thermal noise level.

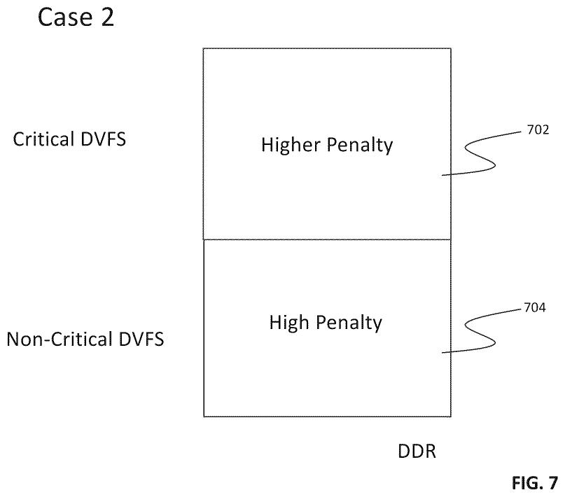

FIG. 7 depicts the scoring procedure according to case 2. In case 2, the processor and DDR memory performance may be of primary concern. In this manner, if the interference of both the processor and DDR are from DDR DVFS points, and if their levels are above a predetermined threshold, then interference from a critical DVFS point receives a higher penalty 702 than interference from a non-critical DVFS point, which may merely receive a high penalty 704. That is, in a non-limiting example, interference corresponding to a non-critical DVFS point could receive a penalty of 0 or 1, whereas interference corresponding to a critical DVFS point could receive a penalty of 1 or 2.

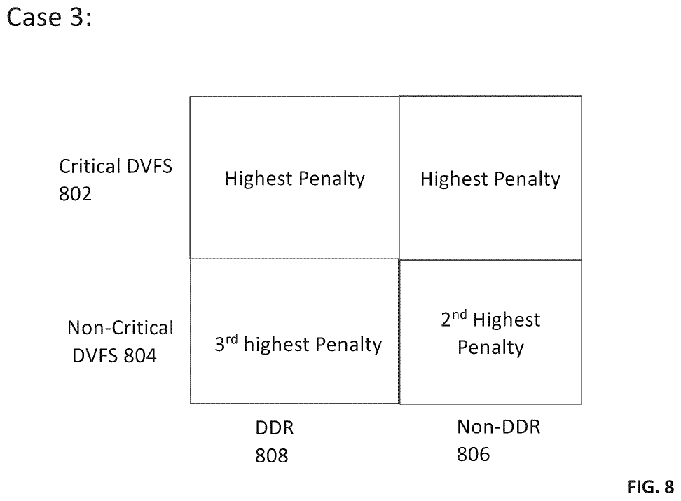

FIG. 8 depicts the scoring procedure according to case 3. In case 3, the scoring algorithm considers trade-offs between the performance of the Wi-Fi and the performance of the processor and/or memory. In this manner, interference from a critical DVFS point 802 may receive a high, or even the highest, penalty score, whereas interference from a non-critical DVFS point 804 may receive a lesser penalty. Similarly, interference from a high severity non-DDR platform noise 806 (e.g., a non-DDR platform noise that is at least 10 dB higher than other non-DDR interference) may receive a high, or even the highest, penalty score, but interference from a DDR platform 808 may receive the highest or the third highest penalty, depending on whether the interference corresponds to a critical DVFS point 802 or a non-critical DVFS point 804. Interference from a non-critical DVFS point receives a lower penalty score than the interference from a critical DVFS point. Interference from a non-DDR platform may receive a moderate penalty, such as, in one example, a second highest penalty score.

It is expressly noted that the penalty scores used herein are for demonstrative purposes only and are not intended to be limiting. Whereas the penalty score scale used herein has been 0 to 3, wherein 0 represents the lowest penalty score, and 3 represents the highest penalty score, the skilled person will appreciate that the penalty scores may be on any scale whatsoever. For example, the scores may be 0 to 10, 0 to 100, or have any other upper or lower boundary. Moreover, although the penalty scores used herein have been integers, non-integer penalty scores are also possible, such that the penalty scores range from 0 to 1 or in any other configuration.

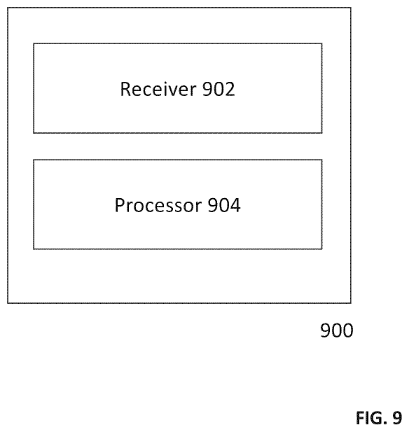

FIG. 9 depicts a device 900. The device 900 may include a receiver 902, which may be configured to communicate with an rate multiple APs. The receiver 902 may be configured to receive a first signal from a first internet access point (AP) transmitting on a first channel, and receive a second signal from a second internet AP transmitting on a second channel. The device 900 may further include a processor 904. The processor 904 may be configured to determine a platform noise of the device. This may optionally include determining a platform noise of the device 900 at every accessible channel. The processor 904 may be further configured to determine a first interference of the platform noise of the device in the first channel and a second interference of the platform noise of the device in the second channel;

generate a first ranking of the first AP based on aa relationship between the first signal and the first interference; generate a second ranking of the second AP based on a relationship between the second signal and the second interference; and select either the first AP or the second AP for connection based on the first ranking and the second ranking.

The processor 904 may be further configured to generate the first ranking based on the first signal, a bandwidth of the first channel, a received signal strength indicator of the first signal, and a load of the first AP; and wherein the processor being configured to generate the second ranking based on the second signal comprises the processor being configured to generate the second ranking based any of a bandwidth of the second channel, a received signal strength indicator of the second signal, and a load of the second AP. In this manner, the processor 904 determining the platform noise of the device may include the processor 904 determining its double data rate (DDR) memory data rates according to a dynamic voltage and frequency scaling (DVFS) setting of the device, and obtaining a corresponding platform noise value based on the determined dynamic voltage and frequency scaling setting using a look-up table. The look-up table may optionally include a plurality of channels, and a corresponding platform noise value for each channel of the plurality of channels. The look-up table may optionally include a plurality of channels, and for each channel of the plurality of channels, a ranking penalty based on a corresponding platform noise value and criticality of DVFS points; for example, the maximum DDR data rate DVFS point is critical for the device performance while one of middle points is not considered as a critical DVFS point.

The processor 904 determining the first interference may optionally include that the processor determines an interference based on the platform noise and a frequency of the first channel. The processor 904 determining the second interference may include the processor determining an interference based on the platform noise and a frequency of the second channel. When either the first or the second interference level impacts wireless connection reliability and the throughput performance, then the AP score penalty value may be applied.

The device 900 may consider a plurality of critical dynamic voltage and frequency scaling points in these determines. That is, the processor 904 may be configured to generate the first ranking by assigning a first penalty value to the first AP if the first interference is from a double data rate memory and corresponds to a dynamic voltage and frequency scaling point other than the plurality of critical dynamic voltage and frequency scaling points; and assigning a second penalty value to the first AP if the first interference is from a source other than a double data rate memory. The second penalty value may be greater than the first penalty value. Here, the interference from double data rate memory corresponding to a dynamic voltage and frequency scaling point other than the plurality of critical dynamic voltage and frequency scaling points may receive a lower penalty because the point could be avoided dynamically, such as by using a known FR interference mitigation tool without significant processor/memory performance reduction. On other hand, the interference from a source other than double data rate memory may have no dynamic voltage and frequency scaling points and thus no possibility of escaping the interference condition.

The device 900 may further include a plurality of critical dynamic voltage and frequency scaling points. In this manner, the processor 904 may be further configured to generate the first ranking by assigning a first penalty value to the first AP if the first interference is from a double data rate memory and corresponds to a dynamic voltage and frequency scaling point other than the plurality of critical dynamic voltage and frequency scaling points; and assigning a second penalty value to the first AP if the first interference corresponds to a critical dynamic voltage and frequency scaling point of the plurality of critical dynamic voltage and frequency scaling points, wherein the second penalty value is greater than the first penalty value.

The device 900 may further include a plurality of critical dynamic voltage and frequency scaling points, wherein the processor 904 being configured to generate the first ranking comprises the processor 904 being configured to assign a first penalty value to the first AP if the first interference is from a source other than a double data rate memory; and to assign a second penalty value to the first AP if the first interference corresponds to a critical dynamic voltage and frequency scaling point of the plurality of critical dynamic voltage and frequency scaling points; and wherein the second penalty value is greater than the first penalty value.

The device 900 may further include a plurality of critical dynamic voltage and frequency scaling points; wherein the processor 904 is further configured to assign a first penalty value to the first AP if the first interference is from a double data rate memory and corresponds to a dynamic voltage and frequency scaling point other than the plurality of the critical dynamic voltage and frequency scaling points; to assign a second penalty value, greater than the first penalty value, if the first interference is from a component other than a double data rate memory and wherein a magnitude of the platform noise is less than a predetermined threshold; and to assign a third penalty value, greater than the second penalty value, if the first interference is less is from a double data rate memory and corresponds to a critical dynamic voltage and frequency scaling point of the plurality of the critical dynamic voltage and frequency scaling points and the magnitude of the platform noise is less than the predetermined threshold, or if the first interference is from a component other than a double data rate memory and the magnitude of the platform noise is greater than the predetermined threshold.

Once the penalties are assigned, the device may calculate scores for the plurality of APs and select an AP to which the device will connect based on the AP having the most preferential score (e.g., a lowest score). The processor 904 may be further configured to cause the device to connect to the selected AP.

The device 900 as disclosed herein may be the client device described above. The device may be configured as any device having a processor and a Wi-Fi receiver, which may include, but is not limited to, a modem, a smart phone, a personal computer, a tablet computer, or a wearable device.

Additional aspects of the invention will be disclosed by way of example.

In Example 1, a device, comprising: a receiver, configured to: receive a first signal from a first internet access point (AP) transmitting on a first channel, and receive a second signal from a second internet AP transmitting on a second channel; and a processor, configured to: determine a first interference resulting from platform noise of the device in at least a frequency of the first channel and a second interference resulting from platform noise of the device in at least a frequency of the second channel; generate a first ranking of the first AP based on a relationship of the first signal to the first interference; generate a second ranking of the second AP based on a relationship of the second signal to the second interference; and select either the first AP or the second AP for connection based on the first ranking and the second ranking.

In Example 2, the device of Example 1, wherein the processor being configured to generate the first ranking based on the first signal comprises the processor being configured to generate the first ranking based any of a bandwidth of the first channel, a received signal strength indicator of the first signal, and a load of the first AP; and wherein the processor being configured to generate the second ranking based on the second signal comprises the processor being configured to generate the second ranking based any of a bandwidth of the second channel, a received signal strength indicator of the second signal, and a load of the second AP.

In Example 3, the device of Example 1 or 2, wherein the processor determining the platform noise of the device comprises the processor determining its double data rate (DDR) memory data rates according to a dynamic voltage and frequency scaling (DVFS) setting of the device, and obtaining a corresponding platform noise value based on the determined DVFS setting using a look-up table.

In Example 4, the device of Example 3, wherein the look-up table comprises a plurality of channels, and a corresponding platform noise value for each channel of the plurality of channels.

In Example 5, the device of Example 3 or 4, wherein the look-up table comprises a plurality of channels, and for each channel of the plurality of channels, a ranking penalty based on a corresponding platform noise value and a criticality of a corresponding DVFS point.

In Example 6, the device of any one of Examples 3 to 5, wherein the processor determining the first interference comprises the processor determining an interference based on the platform noise and a frequency of the first channel; and wherein the processor determining the second interference comprises the processor determining an interference based on the platform noise and a frequency of the second channel; wherein the generating the first ranking comprises the processor applying a penalty to the first internet AP when the first interference interferes with the first channel, and wherein the generating the second ranking comprises the processor applying a penalty to the second internet AP when the second interference interferes with the second channel.

In Example 7, the device of any one of Examples 1 to 6, further comprising a plurality of critical dynamic voltage and frequency scaling points; wherein the processor being configured to generate the first ranking comprises the processor being configured to assign a first penalty value to the first AP if the first interference is from a double data rate memory and corresponds to a non-critical dynamic voltage and frequency scaling point; and to assign a second penalty value to the first AP if the first interference is from a double data rate memory and corresponds to a critical dynamic voltage and frequency scaling point; wherein the second penalty is greater than the first penalty.

In Example 8, the device of any one of Examples 1 to 7, further comprising a plurality of critical dynamic voltage and frequency scaling points; wherein the processor being configured to generate the first ranking comprises the processor being configured to assign a first penalty value to the first AP if the first interference is from a source other than a double data rate memory; and to assign a second penalty value to the second AP if the first interference corresponds to a dynamic voltage and frequency scaling point other than the plurality of critical dynamic voltage and frequency scaling points; and wherein the second penalty value is lower than the first penalty value.

In Example 9, the device of any one of Examples 1 to 8, further comprising a plurality of critical dynamic voltage and frequency scaling points; wherein the processor is further configured to assign a first penalty value to the first AP if the first interference is from a double data rate memory and corresponds to a dynamic voltage and frequency scaling point other than the plurality of the critical dynamic voltage and frequency scaling points; to assign a second penalty value, greater than the first penalty value, if the first interference is from a component other than a double data rate memory and wherein a magnitude of the platform noise is less than a predetermined threshold; and to assign a third penalty value, greater than the second penalty value, if the first interference is less is from a double data rate memory and corresponds to a critical dynamic voltage and frequency scaling point of the plurality of the critical dynamic voltage and frequency scaling points and the magnitude of the platform noise is less than the predetermined threshold, or if the first interference is from a component other than a double data rate memory and the magnitude of the platform noise is greater than the predetermined threshold.

In Example 10, the device of any one of Examples 1 to 9, wherein the processor is further configured to cause the device to connect to the selected AP.

In Example 11, the device of any one of Examples 1 to 10, wherein the device is configured as a modem, a smart phone, a personal computer, a tablet computer, or a wearable device.

In Example 12, a device, comprising: a receiving means for: receiving a first signal from a first internet access point (AP) transmitting on a first channel, and receiving a second signal from a second internet AP transmitting on a second channel; and a penalty calculation means for: determining a first interference resulting from platform noise of the device in at least a frequency of the first channel and a second interference resulting from platform noise of the device in at least a frequency of the second channel; generating a first ranking of the first AP based on a relationship of the first signal to the first interference; generating a second ranking of the second AP based on a relationship of the second signal to the second interference; and selecting either the first AP or the second AP for connection based on the first ranking and the second ranking.

In Example 13, the device of Example 12, wherein the penalty calculation means being configured to generate the first ranking based on the first signal comprises the penalty calculation means being configured to generate the first ranking based any of a bandwidth of the first channel, a received signal strength indicator of the first signal, and a load of the first AP; and wherein the penalty calculation means being configured to generate the second ranking based on the second signal comprises the penalty calculation means being configured to generate the second ranking based any of a bandwidth of the second channel, a received signal strength indicator of the second signal, and a load of the second AP.

In Example 14, the device of Example 12 or 13, wherein the penalty calculation means determining the platform noise of the device comprises the penalty calculation means determining its double data rate (DDR) memory data rates according to a dynamic voltage and frequency scaling (DVFS) setting of the device, and obtaining a corresponding platform noise value based on the determined DVFS setting using a look-up table.

In Example 15, the device of Example 14, wherein the look-up table comprises a plurality of channels, and a corresponding platform noise value for each channel of the plurality of channels.

In Example 16, the device of Example 14 or 15, wherein the look-up table comprises a plurality of channels, and for each channel of the plurality of channels, a ranking penalty based on a corresponding platform noise value and a criticality of a corresponding DVFS point.

In Example 17, the device of any one of Examples 14 to 16, wherein the penalty calculation means determining the first interference comprises the penalty calculation means determining an interference based on the platform noise and a frequency of the first channel; and wherein the penalty calculation means determining the second interference comprises the penalty calculation means determining an interference based on the platform noise and a frequency of the second channel; wherein the generating the first ranking comprises the penalty calculation means applying a penalty to the first internet AP when the first interference interferes with the first channel, and wherein the generating the second ranking comprises the penalty calculation means applying a penalty to the second internet AP when the second interference interferes with the second channel.

In Example 18, the device of any one of Examples 12 to 17, further comprising a plurality of critical dynamic voltage and frequency scaling points; wherein the penalty calculation means being configured to generate the first ranking comprises the penalty calculation means being configured to assign a first penalty value to the first AP if the first interference is from a double data rate memory and corresponds to a non-critical dynamic voltage and frequency scaling point; and to assign a second penalty value to the first AP if the first interference is from a double data rate memory and corresponds to a critical dynamic voltage and frequency scaling point; wherein the second penalty is greater than the first penalty.

In Example 19, the device of any one of Examples 12 to 18, further comprising a plurality of critical dynamic voltage and frequency scaling points; wherein the penalty calculation means being configured to generate the first ranking comprises the penalty calculation means being configured to assign a first penalty value to the first AP if the first interference is from a source other than a double data rate memory; and to assign a second penalty value to the second AP if the first interference corresponds to a dynamic voltage and frequency scaling point other than the plurality of critical dynamic voltage and frequency scaling points; and wherein the second penalty value is lower than the first penalty value.

In Example 20, the device of any one of Examples 12 to 19, further comprising a plurality of critical dynamic voltage and frequency scaling points; wherein the penalty calculation means is further configured to assign a first penalty value to the first AP if the first interference is from a double data rate memory and corresponds to a dynamic voltage and frequency scaling point other than the plurality of the critical dynamic voltage and frequency scaling points; to assign a second penalty value, greater than the first penalty value, if the first interference is from a component other than a double data rate memory and wherein a magnitude of the platform noise is less than a predetermined threshold; and to assign a third penalty value, greater than the second penalty value, if the first interference is less is from a double data rate memory and corresponds to a critical dynamic voltage and frequency scaling point of the plurality of the critical dynamic voltage and frequency scaling points and the magnitude of the platform noise is less than the predetermined threshold, or if the first interference is from a component other than a double data rate memory and the magnitude of the platform noise is greater than the predetermined threshold.

In Example 21, the device of any one of Examples 12 to 20, wherein the penalty calculation means is further configured to cause the device to connect to the selected AP.

In Example 22, the device of any one of Examples 12 to 21, wherein the device is configured as a modem, a smart phone, a personal computer, a tablet computer, or a wearable device.

In Example 23, a method of access point (AP) selection, comprising: receiving a first signal from a first internet AP transmitting on a first channel; receiving a second signal from a second internet AP transmitting on a second channel; determining a first interference resulting from platform noise of the device in at least a frequency of the first channel and a second interference resulting from platform noise of the device in at least a frequency of the second channel; generating a first ranking of the first AP based on a relationship of the first signal to the first interference; generating a second ranking of the second AP based on a relationship of the second signal to the second interference; and selecting either the first AP or the second AP for connection based on the first ranking and the second ranking.

In Example 24, the method of Example 23, wherein the generating the first ranking based on the first signal comprises generating the first ranking based any of a bandwidth of the first channel, a received signal strength indicator of the first signal, and a load of the first AP; and wherein the generating the second ranking based on the second signal comprises generating the second ranking based any of a bandwidth of the second channel, a received signal strength indicator of the second signal, and a load of the second AP.

In Example 25, the method of Example 23 or 24, wherein the determining the platform noise of the device comprises determining its double data rate (DDR) memory data rates according to a dynamic voltage and frequency scaling (DVFS) setting of the device, and obtaining a corresponding platform noise value based on the determined DVFS setting using a look-up table.

In Example 26, the method of Example 25, wherein the look-up table comprises a plurality of channels, and a corresponding platform noise value for each channel of the plurality of channels.

In Example 27, the method of Example 25 or 26, wherein the look-up table comprises a plurality of channels, and for each channel of the plurality of channels, a ranking penalty based on a corresponding platform noise value and a criticality of a corresponding DVFS point.

In Example 28, the method of any one of Examples 25 to 27, wherein the determining the first interference comprises determining an interference based on the platform noise and a frequency of the first channel; and wherein the determining the second interference comprises determining an interference based on the platform noise and a frequency of the second channel; wherein the generating the first ranking comprises the processor applying a penalty to the first internet AP when the first interference interferes with the first channel, and wherein the generating the second ranking comprises the processor applying a penalty to the second internet AP when the second interference interferes with the second channel.

In Example 29, the method of any one of Examples 23 to 28, further comprising a plurality of critical dynamic voltage and frequency scaling points; wherein the generating the first ranking comprises assigning a first penalty value to the first AP if the first interference is from a double data rate memory and corresponds to a non-critical dynamic voltage and frequency scaling point; and assigning a second penalty value to the first AP if the first interference is from a double data rate memory and corresponds to a critical dynamic voltage and frequency scaling point; wherein the second penalty is greater than the first penalty.

In Example 30, the method of any one of Examples 23 to 29, further comprising a plurality of critical dynamic voltage and frequency scaling points; wherein the generating the first ranking comprises assigning a first penalty value to the first AP if the first interference is from a source other than a double data rate memory; and assigning a second penalty value to the second AP if the first interference corresponds to a dynamic voltage and frequency scaling point other than the plurality of critical dynamic voltage and frequency scaling points; and wherein the second penalty value is lower than the first penalty value.

In Example 31, the method of any one of Examples 23 to 30, further comprising a plurality of critical dynamic voltage and frequency scaling points; further comprising assigning a first penalty value to the first AP if the first interference is from a double data rate memory and corresponds to a dynamic voltage and frequency scaling point other than the plurality of the critical dynamic voltage and frequency scaling points; assigning a second penalty value, greater than the first penalty value, if the first interference is from a component other than a double data rate memory and wherein a magnitude of the platform noise is less than a predetermined threshold; and assigning a third penalty value, greater than the second penalty value, if the first interference is less is from a double data rate memory and corresponds to a critical dynamic voltage and frequency scaling point of the plurality of the critical dynamic voltage and frequency scaling points and the magnitude of the platform noise is less than the predetermined threshold, or if the first interference is from a component other than a double data rate memory and the magnitude of the platform noise is greater than the predetermined threshold.

In Example 32, the method of any one of Examples 23 to 31, further comprising causing the device to connect to the selected AP.

In Example 33, a non-transitory computer readable medium, comprising instructions which, if executed by a processor, cause the processor to: receive first data corresponding to a first signal from a first internet AP transmitting on a first channel; receive second data corresponding to a second signal from a second internet AP transmitting on a second channel; determine a first interference resulting from platform noise of the device in at least a frequency of the first channel and a second interference resulting from platform noise of the device in at least a frequency of the second channel; generate a first ranking of the first AP based on a relationship of the first signal to the first interference; generate a second ranking of the second AP based on a relationship of the second signal to the second interference; and select either the first AP or the second AP for connection based on the first ranking and the second ranking.

In Example 34, the non-transitory computer readable medium of Example 33, wherein the generating the first ranking based on the first signal comprises generating the first ranking based any of a bandwidth of the first channel, a received signal strength indicator of the first signal, and a load of the first AP; and wherein the generating the second ranking based on the second signal comprises generating the second ranking based any of a bandwidth of the second channel, a received signal strength indicator of the second signal, and a load of the second AP.

In Example 35, the non-transitory computer readable medium of Example 33 or 34, wherein the determining the platform noise of the device comprises determining its double data rate (DDR) memory data rates according to a dynamic voltage and frequency scaling (DVFS) setting of the device, and obtaining a corresponding platform noise value based on the determined DVFS setting using a look-up table.

In Example 36, the non-transitory computer readable medium of Example 35, wherein the look-up table comprises a plurality of channels, and a corresponding platform noise value for each channel of the plurality of channels.

In Example 37, the non-transitory computer readable medium of Example 35 or 36, wherein the look-up table comprises a plurality of channels, and for each channel of the plurality of channels, a ranking penalty based on a corresponding platform noise value and a criticality of a corresponding DVFS point.

In Example 38, the non-transitory computer readable medium of any one of Examples 35 to 37, wherein the determining the first interference comprises determining an interference based on the platform noise and a frequency of the first channel; and wherein the determining the second interference comprises determining an interference based on the platform noise and a frequency of the second channel; wherein the generating the first ranking comprises the processor applying a penalty to the first internet AP when the first interference interferes with the first channel, and wherein the generating the second ranking comprises the processor applying a penalty to the second internet AP when the second interference interferes with the second channel.

In Example 39, the non-transitory computer readable medium of any one of Examples 33 to 38, further comprising a plurality of critical dynamic voltage and frequency scaling points; wherein the generating the first ranking comprises assigning a first penalty value to the first AP if the first interference is from a double data rate memory and corresponds to a non-critical dynamic voltage and frequency scaling point; and assigning a second penalty value to the first AP if the first interference is from a double data rate memory and corresponds to a critical dynamic voltage and frequency scaling point; wherein the second penalty is greater than the first penalty.

In Example 40, the non-transitory computer readable medium of any one of Examples 33 to 39, further comprising a plurality of critical dynamic voltage and frequency scaling points; wherein the generating the first ranking comprises assigning a first penalty value to the first AP if the first interference is from a source other than a double data rate memory; and assigning a second penalty value to the second AP if the first interference corresponds to a dynamic voltage and frequency scaling point other than the plurality of critical dynamic voltage and frequency scaling points; and wherein the second penalty value is lower than the first penalty value.

In Example 41, the non-transitory computer readable medium of any one of Examples 33 to 40, further comprising a plurality of critical dynamic voltage and frequency scaling points; further comprising assigning a first penalty value to the first AP if the first interference is from a double data rate memory and corresponds to a dynamic voltage and frequency scaling point other than the plurality of the critical dynamic voltage and frequency scaling points; assigning a second penalty value, greater than the first penalty value, if the first interference is from a component other than a double data rate memory and wherein a magnitude of the platform noise is less than a predetermined threshold; and assigning a third penalty value, greater than the second penalty value, if the first interference is less is from a double data rate memory and corresponds to a critical dynamic voltage and frequency scaling point of the plurality of the critical dynamic voltage and frequency scaling points and the magnitude of the platform noise is less than the predetermined threshold, or if the first interference is from a component other than a double data rate memory and the magnitude of the platform noise is greater than the predetermined threshold.

In Example 42, the non-transitory computer readable medium of any one of Examples 33 to 41, further comprising causing the device to connect to the selected AP.

While the above descriptions and connected figures may depict components as separate elements, skilled persons will appreciate the various possibilities to combine or integrate discrete elements into a single element. Such may include combining two or more circuits for form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method.

All acronyms defined in the above description additionally hold in all claims included herein.

What is claimed is:

1. A device, comprising:
a receiver, configured to:
receive a first signal from a first internet access point (AP) transmitting on a first channel, and
receive a second signal from a second internet AP transmitting on a second channel; and a processor, configured to:
determine a first interference resulting from platform noise of the device in at least a frequency of the first channel and a second interference resulting from platform noise of the device in at least a frequency of the second channel;
generate a first ranking of the first AP based on a relationship of the first signal to the first interference;
generate a second ranking of the second AP based on a relationship of the second signal to the second interference; and
select either the first AP or the second AP for connection based on the first ranking and the second ranking.

2. The device of claim 0, wherein the processor configured to generate the first ranking of the first AP based on the relationship of the first signal to the first interference further comprises:
generate the first ranking based on any of a bandwidth of the first channel, a received signal strength indicator of the first signal, or a load of the first AP; and
wherein the processor configured to generate the second ranking of the second AP based on the relationship of the second signal to the second interference further comprises: generate the second ranking based on any of a bandwidth of the second channel, a received signal strength indicator of the second signal, or a load of the second AP.

3. The device of claim 0, wherein the processor being configured to determine the first interference resulting from platform noise of the device comprises the processor being configured to determine its double data rate (DDR) memory data rates according to a dynamic voltage and frequency scaling (DVFS) setting of the device, and to obtain a corresponding platform noise value based on the determined DVFS setting using a look-up table.

4. The device of claim 23, wherein the look-up table comprises a plurality of channels, and a corresponding platform noise value for the plurality of channels.

5. The device of claim 23, wherein the look-up table comprises a plurality of channels, and for each channel of the plurality of channels, a ranking penalty based on a corresponding platform noise value and a criticality of a corresponding DVFS point.

6. The device of claim 23, wherein the processor determining the first interference comprises the processor determining an interference based on the platform noise and a frequency of the first channel; and wherein the processor determining the second interference comprises the processor determining an interference based on the platform noise and a frequency of the second channel; wherein the generating the first ranking comprises the processor applying a penalty to the first internet AP in response to the first interference interfering with the first channel; and wherein the generating the second ranking comprises the processor applying a penalty to the second internet AP in response to the second interference interfering with the second channel.

7. The device of claim 0, further comprising a plurality of dynamic voltage and frequency scaling points; wherein the processor being configured to generate the first ranking comprises the processor being configured to assign a first penalty value to the first AP in response to the first interference being from a double data rate memory and corresponding to a non-critical dynamic voltage and frequency scaling point; and to assign a second penalty value to the first AP in response to the first interference being from a double data rate memory and corresponding to a critical dynamic voltage and frequency scaling point; and wherein the second penalty value is greater than the first penalty value.

8. The device of claim 0, further comprising a plurality of critical dynamic voltage and frequency scaling points; wherein the processor being configured to generate the first ranking comprises the processor being configured to assign a first penalty value to the first AP if the first interference is from a source other than a double data rate memory; and to assign a second penalty value to the second AP if the first interference corresponds to a dynamic voltage and frequency scaling point other than the plurality of critical dynamic voltage and frequency scaling points; and wherein the second penalty value is lower than the first penalty value.

9. The device of claim 0, further comprising a plurality of critical dynamic voltage and frequency scaling points; wherein the processor is further configured to assign a first penalty value to the first AP if the first interference is from a double data rate memory and corresponds to a dynamic voltage and frequency scaling point other than the plurality of the critical dynamic voltage and frequency scaling points; to assign a second penalty value, greater than the first penalty value, if the first interference is from a component other than a double data rate memory and wherein a magnitude of the platform noise is less than a predetermined threshold; and to assign a third penalty value, greater than the second penalty value, if the first interference is less is from a double data rate memory and corresponds to a critical dynamic voltage and frequency scaling point of the plurality of the critical dynamic voltage and frequency scaling points and the magnitude of the platform noise is less than the predetermined threshold, or if the first interference is from a component other than a double data rate memory and the magnitude of the platform noise is greater than the predetermined threshold.

10. The device of claim 0, wherein the processor is further configured to cause the device to connect to the selected AP.

11. The device of claim 0, wherein the device is configured as a modem, smart phone, personal computer, tablet computer, or wearable device.

1212. A method of access point (AP) selection, comprising:
receiving a first signal from a first internet AP transmitting on a first channel;
receiving a second signal from a second internet AP transmitting on a second channel;
determining a first interference resulting from platform noise of a device in at least a frequency of the first channel and a second interference resulting from platform noise of the device in at least a frequency of the second channel;
generating a first ranking of the first AP based on a relationship of the first signal to the first interference;
generating a second ranking of the second AP based on a relationship of the second signal to the second interference; and
selecting either the first AP or the second AP for connection based on the first ranking and the second ranking.

13. The method of claim 12, wherein the generating the first ranking of the AP based on the relationship of the first signal to the first interference comprises generating the first ranking based on any of a bandwidth of the first channel, a received signal strength indicator of the first signal, or a load of the first AP; and
wherein the generating the second ranking of the second AP based on the relationship of the second signal to the second interference comprises generating the second ranking based on any of a bandwidth of the second channel, a received signal strength indicator of the second signal, or a load of the second AP.

14. The method of claim 12, wherein the determining the first interference resulting from the platform noise of the device comprises determining its double data rate (DDR) memory data rates according to a dynamic voltage and frequency scaling (DVFS) setting of the device, and obtaining a corresponding platform noise value based on the determined DVFS setting using a look-up table.

15. The method of claim 1314, wherein the look-up table comprises a plurality of channels, and a corresponding platform noise value for the plurality of channels.

16. The method of claim 1314, wherein the look-up table comprises a plurality of channels and a ranking penalty based on a corresponding platform noise value and a criticality of a corresponding DVFS point.

17. The method of claim 1314, wherein the determining the first interference comprises determining an interference based on the platform noise and a frequency of the first channel; and
wherein the determining the second interference comprises determining an interference based on the platform noise and a frequency of the second channel; wherein the generating the first ranking comprises applying a penalty to the first internet AP when the first interference interferes with the first channel; and wherein the generating the second ranking comprises applying a penalty to the second internet AP when the second interference interferes with the second channel.

1819. A non-transitory computer readable medium, comprising instructions which, if executed by a processor, cause the processor to:
receive first data corresponding to a first signal from a first internet AP transmitting on a first channel;
receive second data corresponding to a second signal from a second internet AP transmitting on a second channel;
determine a first interference resulting from platform noise of a device in at least a frequency of the first channel and a second interference resulting from platform noise of the device in at least a frequency of the second channel;
generate a first ranking of the first AP based on a relationship of the first signal to the first interference;
generate a second ranking of the second AP based on a relationship of the second signal to the second interference; and
select either the first AP or the second AP for connection based on the first ranking and the second ranking.

1819. The non-transitory computer readable medium of claim 18, wherein the generating the first ranking of the first AP based on the first signal comprises generating the first ranking based any of a bandwidth of the first channel, a received signal strength indicator of the first signal, or a load of the first AP; and
wherein the generating the second ranking of the second AP based on the second signal comprises generating the second ranking based any of a bandwidth of the second channel, a received signal strength indicator of the second signal, or a load of the second AP.

20. The non-transitory computer readable medium of claim 18, wherein the determining the platform noise of the device comprises determining its double data rate (DDR) memory data rates according to a dynamic voltage and frequency scaling (DVFS) setting of the device, and obtaining a corresponding platform noise value based on the determined DVFS setting using a look-up table.
